(19) United States
(12) Patent Application Publication
(10) Pub. No.: US 2015/0372474 A1
(43) Pub. Date: Dec. 24, 2015

(54) CIRCUIT INTERRUPTION DEVICE

(71) Applicant: ALSTOM TECHNOLOGY LTD, Baden (CH)

(72) Inventors: Colin Charnock Davidson, Stafford (GB); Robert Whitehouse, Stafford (GB)

(73) Assignee: ALSTOM TECHNOLOGY LTD, Baden (CH)

(21) Appl. No.: 14/767,398

(22) PCT Filed: Nov. 20, 2013
(86) PCT No.: PCT/EP2013/074305

§ 371 Date: Aug. 12, 2015

(30) Foreign Application Priority Data
Feb. 13, 2013 (EP) 13275031.6

(51) Int. Cl. H02H 3/087

(52) U.S. Cl. CPC H02H 3/087

(57) ABSTRACT

A circuit interruption device includes a main branch; a secondary branch having an electrical on-resistance which is higher than an electrical on-resistance of the main branch; and first and second terminals for connection to an electrical network, the main and secondary branches extending between the first and second terminals. The main branch includes a switching apparatus which is switchable to selectively allow current to flow in the main branch in a normal mode of operation or commutate current from the main branch to the secondary branch in a fault mode of operation. The secondary branch includes a switching device, the switching device including a normally-on switching element. The secondary branch further includes a control unit in communication with the normally-on switching element. The secondary branch further includes a power extraction circuit which is electrically coupled with the control unit. During the normal mode of operation the normally-on switching element is in an on-state to permit the secondary branch to conduct current, and during the fault mode of operation the control unit controls the switching of the or each normally-on switching element to an off-state to inhibit current flow in the secondary branch.

This invention relates to a circuit interruption device and a circuit interruption device assembly.

In power transmission networks alternating current (AC) power is typically converted to direct current (DC) power for transmission via overhead lines and/or undersea cables. This conversion removes the need to compensate for the AC capacitive load effects imposed by the transmission line or cable, and thereby reduces the cost per kilometer of the lines and/or cables. Conversion from AC to DC thus becomes cost-effective when power needs to be transmitted over a long distance.

The conversion of AC to DC power is also utilized in power transmission networks where it is necessary to interconnect AC networks operating at different frequencies. In any such power transmission network, converters are required at each interface between AC and DC power to effect the required conversion.

HVDC converters are vulnerable to DC side faults or other abnormal operating conditions that can present a short circuit with low impedance across the DC power transmission lines or cables. Such faults can occur due to damage or breakdown of insulation, lightning strikes, movement of conductors or other accidental bridging between conductors by a foreign object.

The presence of low impedance across the DC power transmission lines or cables can be detrimental to a HVDC converter. Sometimes the inherent design of the converter means that it cannot limit current under such conditions, resulting in the development of a high fault current exceeding the current rating of the HVDC converter. Such a high fault current not only damages components of the HVDC converter, but also results in the HVDC converter being offline for a period of time. This results in increased cost of repair and maintenance of damaged electrical apparatus hardware, and inconvenience to end users relying on the working of the electrical apparatus. It is therefore important to be able to interrupt the high fault current as soon as it is detected.

A conventional means of protecting a HVDC converter from DC side faults, in cases where the converter control cannot limit the fault current by any other means, is to trip an AC side circuit breaker, thus removing the supply of current that feeds the fault through the HVDC converter to the DC side. This is because there are currently no commercially available HVDC circuit breaker designs. Furthermore, almost all HVDC schemes are currently point-to-point schemes with two HVDC converters connected to the DC side, whereby one HVDC converter acts as a power source with power rectification capability and the other HVDC converter acts as a power load with power inversion capability. Hence, tripping the AC side circuit breaker is acceptable because the presence of a fault in the point-to-point scheme requires interruption of power flow to allow the fault to be cleared.

A new class of HVDC power transmission networks are being considered for moving large quantities of power over long distances, as required by geographically dispersed renewable forms of generation, and to augment existing capabilities of AC power transmission networks with smartgrid intelligence and features that are able to support modern electricity trading requirements.

Such a HVDC power transmission network requires multi-terminal interconnection of HVDC converters, whereby power can be exchanged on the DC side using three or more HVDC converters operating in parallel. Each HVDC converter acts as either a source or sink to maintain the overall input-to-output power balance of the network whilst exchanging the power as required. Faults in the HVDC power transmission network need to be quickly isolated and segregated from the rest of the network in order to enable the network to resume normal power transmission as soon as possible.

Current interruption in conventional AC circuit breakers is carried out when the current reaches a current zero, so as to considerably reduce the difficulty of the interruption task. Thus, in conventional circuit breakers, there is a risk of damage to the current interruption apparatus if a current zero does not occur within a defined time period for interrupting the current. It is therefore inherently difficult to carry out direct current interruption because, unlike alternating current in which current zeros naturally occur, direct current cannot naturally reach a current zero.

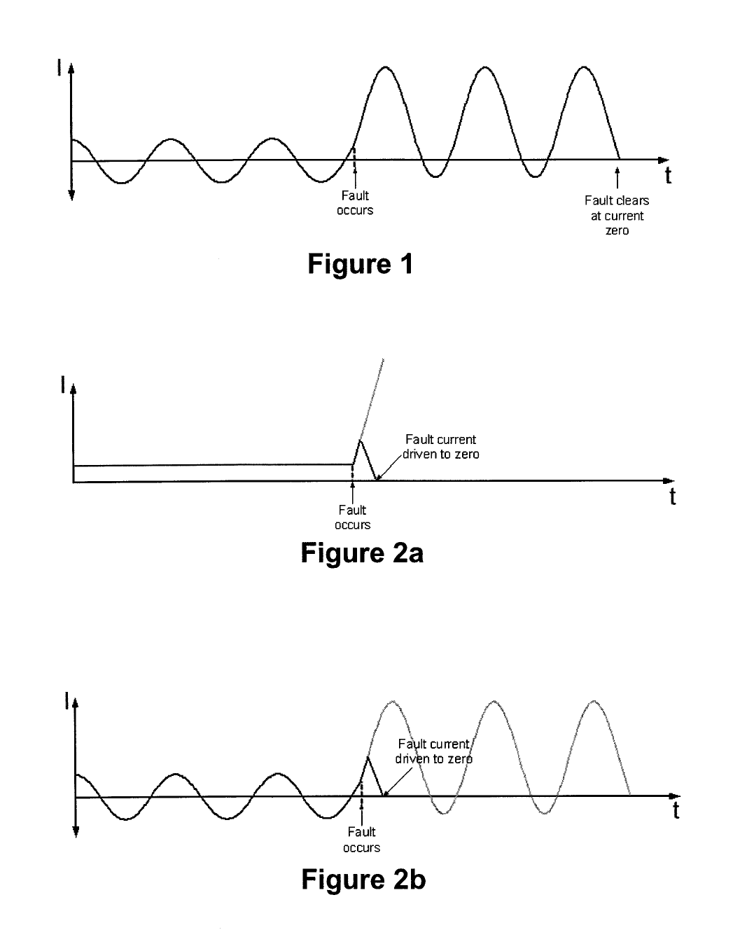

For the same reason, it is inherently difficult to carry out AC interruption within a first half-cycle of a fault current because conventional AC circuit breakers need to wait until the fault current reaches a current zero (at which the fault current can be safely interrupted), which occurs after the fault current reaches a peak and subsequently falls to zero. In addition, mechanical AC circuit breakers are relatively slow and can take up to several cycles (typically up to 50-100 ms) to clear the fault current, as shown in FIG. 1. This not only could lead to an increase in damage due to the high fault alternating current, but also results in an inherent minimum operating time of a conventional AC circuit breaker.

EP 0 867 998 B1 discloses a solid-state DC circuit breaker comprising a stack of series-connected IGBTs in parallel with a metal-oxide surge arrester. This solution achieves a response time in the range of a few milliseconds but suffers from high steady-state power losses.

According to a first aspect of the invention, there is provided a circuit interruption device comprising:
a main branch;
a secondary branch having an electrical on-resistance which is higher than an electrical on-resistance of the main branch; and
first and second terminals for connection, in use, to an electrical network, the main and secondary branches extending between the first and second terminals;
wherein the main branch includes a switching apparatus which is switchable to selectively allow current to flow in the main branch in a normal mode of operation or commutate current from the main branch to the secondary branch in a fault mode of operation, and the secondary branch includes at least one switching device, the or each switching device including at least one normally-on switching element, the secondary branch further including a control unit in communication with the or each normally-on switching element, the secondary branch further including a power extraction circuit which is electrically coupled with the control unit,
wherein during the normal mode of operation the or each normally-on switching element is in an on-state to permit the secondary branch to conduct current, and during the fault mode of operation the control unit controls the switching of the or each normally-on switching element to an off-state to inhibit current flow in the secondary branch,
wherein the power extraction circuit extracts power from current flowing in the secondary branch to drive the control unit.

It will be appreciated that the circuit interruption device according to the invention can be used, without requiring any modification, either as a DC circuit interruption device to interrupt DC or as an AC circuit interruption device to interrupt AC. Thus, for the purposes of the specification, the term “circuit interruption device” is intended to refer to a device that can interrupt either DC or AC.

FIGS. 2a and 2b respectively illustrate examples of current interruption using a DC circuit interruption device and an ultra-fast, sub-cycle AC circuit interruption device configured to be capable of interrupting a fault current while it is still rising. In FIG. 2a, operation of the DC circuit interruption device drives (i.e. forces) a fault current to fall to zero when it begins to rise after occurrence of the fault. In FIG. 2b, operation of the AC circuit interruption device drives (i.e. forces) a fault current to fall to zero when it begins to rise within its first half-cycle after occurrence of the fault.

The only difference between the interrupted currents of FIGS. 2a and 2b is that the current of FIG. 2a has a constant value prior to occurrence of the fault, and the current of FIG. 2b has a time-varying alternating value prior to occurrence of the fault. On the other hand, the current of FIG. 2b during the period between the occurrence of the fault and the forced current zero is similar in shape to the current of FIG. 2a during the period between the occurrence of the fault and the forced current zero, and thereby can be considered to be quasi-DC at this stage. This similarity between the currents of FIGS. 2a and 2b during the period between the occurrence of the fault and the forced current zero means that the operation of the ultra-fast, sub-cycle AC circuit interruption device to interrupt current can be identical to the operation of the DC circuit interruption device to interrupt current.

It will be appreciated therefore that any circuit interruption device that is capable of interrupting direct current is also capable of interrupting an alternating current of equivalent amplitude. It will also be appreciated that any circuit interruption device that is capable of interrupting direct current has the advantage of not having to wait for a natural current zero.

In the normal mode of operation of the circuit interruption device, the switching apparatus is closed and so current from the electrical network flows in the main branch. Meanwhile, although the or each normally-on switching element is in an on-state to permit the secondary branch to conduct current in the normal mode of operation, little to no current flows in the secondary branch as a consequence of the secondary branch having an electrical on-resistance which is higher than an electrical on-resistance of the main branch.

In the event of a fault occurring in the electrical network resulting in high fault current flowing in the main branch, the switching apparatus is opened to commutate the fault current from the main branch to the secondary branch in the fault mode of operation of the circuit interruption device. Since the or each normally-on switching element was already in an on-state to permit the secondary branch to conduct current prior to occurrence of the fault, commutation of the fault current from the main branch to the secondary branch takes place instantaneously. After a certain period of time following commutation of the fault current from the main branch to the secondary branch, the control unit turns off the or each normally-on switching element to complete the circuit interruption process. It will be appreciated that the circuit interruption device may optionally further include one or more energy absorption or dissipation elements, e.g. a snubber circuit or a metal-oxide surge arrestor as described in EP 0 867 998 B1, to assist the circuit interruption procedure.

The aforementioned use and configuration of the or each normally-on switching element in the or each switching device to enable instantaneous commutation of the fault current from the main branch to the secondary branch therefore improves the responsiveness of the circuit interruption device in performing the circuit interruption procedure.

Furthermore the or each normally-on switching element does not need to be energised to be in an on-state. As such, it is not essential to provide constant energisation of the or each normally-on switching element to maintain its on-state in order to permit the secondary branch to conduct current during the normal mode of operation, thus improving the efficiency of the circuit interruption device in terms of operational costs and energy usage.

In contrast, replacing the or each normally-on switching element in the or each switching device with a normally-off switching element would result in a pause between the conduction of the fault current in the main and secondary branches respectively after the switching apparatus is opened, thus inhibiting instantaneous commutation of the fault current from the main branch to the secondary branch. The pause is caused by the time taken to turn on the or each normally-off switching element to permit the secondary branch to conduct current after the switching apparatus is opened.

On the other hand the pause could be eliminated by turning on the or each normally-off switching element to permit the secondary branch to conduct current prior to occurrence of the fault, i.e. during the normal mode of operation. However, a normally-off switching element must be energised to enable its turn-on, i.e. its switching to an on-state, and so such an approach would require constant energisation of the or each normally-off switching element to maintain its on-state to permit the secondary branch to conduct current during the normal mode of operation, thereby resulting in higher operational costs and lower energy efficiency.

As an alternative to providing constant energisation of the or each normally-off switching element, the or each normally-off switching element could be associated with a power supply arrangement which is capable of instantaneously generating power to enable the control unit to turn on the or each normally-on switching element and thereby permit the secondary branch to instantaneously conduct current in response to the opening of the switching apparatus. Although such a power supply arrangement could reduce the operational costs associated with the provision of constant energisation of the or each normally-off switching element, it can be complex and expensive to design and construct the power supply arrangement to be compatible for use with a circuit interruption device requiring high levels of responsiveness and reliability, especially when the circuit interruption device requires a high number of switching devices in its secondary branch.

The turn-off of the or each normally-on switching element of the or each switching device in the fault mode of operation requires energisation of the or each normally-on switching element. Such energisation is provided by the power extraction circuit which, by way of its use to electrically couple the secondary branch and the control unit, extracts power from current flowing in the secondary branch to drive the control unit. This thereby provides the circuit interruption device with the capability to locally derive power for driving the control unit to turn off the or each normally-on switching element.

In contrast, adding a separate power source to the circuit interruption device or hardware for supplying power from ground potential to the control unit would not only increase the structural complexity of the circuit interruption device, but also increase the cost and footprint of the circuit interruption device. Furthermore the duration of the fault mode of operation is much shorter than the duration of normal mode of operation. This means that the separate power source or hardware would only be used infrequently, and so it becomes inefficient in terms of operational costs and energy usage to operate the separate power source or hardware.

The configuration of the circuit interruption device according to the invention therefore results in a cost- and energy-efficient circuit interruption device which can be designed to rapidly and reliably carry out a circuit interruption procedure in response to an occurrence of a fault in an associated electrical network.

The number of switching devices and normally-on switching elements in the secondary branch may vary depending on the design requirements, e.g. voltage and current ratings, losses, response time, of the associated power application. For example, the secondary branch may include a plurality of series-connected switching devices and/or each switching device may include a plurality of parallel-connected normally-on switching elements.

The type of normally-on switching element(s) used in the or each switching device may also vary depending on the design requirements of the associated power application. For example, at least one normally-on switching element may be a semiconductor switching element. The semiconductor switching element may be a depletion-mode switching element, e.g. a depletion-mode MOSFET or JFET. At least one normally-on switching element may include a wide-band-gap semiconductor material such as, but not limited to, silicon carbide, gallium nitride or diamond.

The power extraction circuit may be configured to extract power from current flowing in the secondary branch during the normal and/or fault modes of operation of the circuit interruption device as follows.

For example, during the fault mode of operation, following commutation of current from the main branch to the secondary branch, the power extraction circuit may extract power from current flowing in the secondary branch to drive the control unit,

In embodiments of the invention, the power extraction circuit may include an electrical block which is electrically coupled with the control unit, the electrical block being connected in the secondary branch such that a voltage drop is generated across the electrical block when current flows in the secondary branch. The presence of the voltage drop across the electrical block allows the power extraction circuit to extract power from the current flowing in the secondary branch in the normal and/or fault modes of operation.

Optionally the electrical block may include at least one resistive element.

In the fault mode of operation, although the flow of current through the or each resistive element results in resistive losses, the short duration of the fault mode of operation means that the resistive losses would be minimal.

Further optionally the electrical block may include at least one inductive element, e.g. a reactor or a winding of a current transformer.

When the fault current is commutated from the main branch to the secondary branch, the secondary branch sees a current pulse with a short duration and a high rate of change of current. The high rate of change of current of the current pulse induces a voltage drop across the or each inductive element and thereby enables the power extraction circuit to extract power from the current flowing in the secondary branch.

The use of a current transformer in the electrical block obviates the need for any voltage isolation or “level shifting” which would normally be required for switching devices with an electrical block including a resistor or reactor.

The electrical block may be connected in the secondary branch in various ways to enable generation of a voltage drop across the electrical block when current flows in the secondary branch during the normal and/or fault modes of operation. For example, the electrical block may be connected in series with at least one normally-on switching element.

In further embodiments of the invention employing the use of an electrical block, the electrical block may include at least one normally-on switching element. This allows the power extraction circuit to extract power from the current flowing in the secondary branch by utilising the on-state voltage appearing across the or each corresponding normally-on switching element when current flows in the secondary branch in the normal and/or fault modes of operation.

According to a second aspect of the invention, there is provided a circuit interruption device assembly comprising:
a circuit interruption device according to any embodiment of the first aspect of the invention; and
a current injection circuit including:
   at least one current source for injecting a current into the secondary branch of the circuit interruption device; and
   at least one filter limb operably connected to the secondary branch of the circuit interruption device to inhibit the injected current from flowing, in use, into the electrical network.

In use, the or each current source can be controlled to inject a current into the secondary branch in the normal and/or fault modes of operation. The provision of the current injection circuit enables the power extraction circuit to reliably extract a required amount of power from the current flowing in the secondary branch through the injection of a suitable current, thus improving the reliability of the circuit interruption device.

When the circuit interruption device assembly includes a circuit interruption device employing the use of an electrical block, a voltage drop is generated across the electrical block when the injected current flows in the secondary branch, thereby enabling the power extraction circuit to extract power from the injected current flowing in the secondary branch. For example, when the electrical block includes at least one inductive element, the or each current source may be configured to inject a ripple current into the secondary branch in order to induce a voltage drop across the or each inductive element.

The or each filter limb may include at least one inductive element, at least one capacitive element and/or at least one resistive element.

The or each filter limb defines a line trap which prevents the injected current from entering the associated electrical network. The or each filter limb may be operably connected to the secondary branch of the circuit interruption device in different configurations to inhibit the injected current from flowing, in use, into the electrical network. Examples of the different configurations are described as follows.

In embodiments of the invention, the current injection circuit may include:
a pair of first filter limbs, each first filter limb having first and second ends, the first end of each first filter limb being connectable to the electrical network;
a pair of second filter limbs, each second filter limb having first and second ends, the first end of each second filter limb being connectable to ground or the electrical network, the secondary branch of the circuit interruption device being connected with the second filter limbs to define a Tr-configuration of the secondary branch and second filter limbs in which the secondary branch extends between the second ends of the second filter limbs, the Tr-configuration being connected between the first filter limbs such that the second end of each first filter limb is connected to the second end of a respective one of the second filter limbs.

In such embodiments, the first end of each first filter limb may be connected to a respective one of the first and second terminals of the circuit interruption device. This prevents the injected current from flowing in the main branch of the circuit interruption device.

In other such embodiments, the second end of each first filter limb may be connected to a respective one of the first and second terminals of the circuit interruption device.

When the second end of each first filter limb is connected to a respective one of the first and second terminals of the circuit interruption device, the circuit interruption device assembly may further include a pair of third filter limbs, each third filter limb having first and second ends, wherein the first end of each third filter limb is connected to the first end of a respective one of the second filter limbs, and the second end of each third filter limb is connectable to the electrical network. Optionally the circuit interruption device assembly may further include an additional circuit interruption device according to any embodiment of the first aspect of the invention, the additional circuit interruption device being connected between the first ends of the second filter limbs. Such circuit interruption device assemblies may be directly connected between different poles of the associated electrical network.

The location of the or each current source in the current injection circuit may vary. For example, at least one of the limbs, e.g. at least one of the second filter limbs, may include a current source and/or at least one current source may be connected in series with the first and second terminals between the second ends of the second filter limbs.

The current injection circuit may include a plurality of current sources. This permits redundancy to be added to the current injection circuit for reliability reasons. Nonetheless it will be appreciated that the current injection circuit can be operated using a single current source.

In embodiments employing the use of a current injection circuit, the circuit interruption device assembly may include an energy storage element for storing and releasing power,
wherein during the normal mode of operation the or each current source injects a current into the secondary branch and the power extraction circuit extracts power from the injected current for storage in the energy storage element, and
wherein during the fault mode of operation the energy storage element releases the stored power to drive the control unit.

The provision of an energy storage element enables the circuit interruption device assembly to store power during the normal mode of operation to ensure that a required amount of power is available to drive the control unit during the fault mode of operation. This reduces the reliance on the capability of the power extraction circuit to extract sufficient power solely from the fault current flowing in the secondary branch during the fault mode of operation, thus improving the reliability of the circuit interruption device.

The energy storage element may be rated so that the stored power on its own or in combination with power extracted from the fault current in the fault mode of operation is sufficient to drive the control unit.

The energy storage element may be integral with the control unit, or may be a separate component from the control unit.

In further embodiments employing the use of a current injection circuit, during the fault mode of operation, the or each current source may inject a current into the secondary branch. The or each current source may be rated so that the injected current on its own or in combination with the fault current is sufficient to enable the power extraction circuit to extract the required amount of power from current flowing in the secondary branch to drive the control unit.

It will be appreciated that, in embodiments employing the use of a plurality of normally-on switching elements, the circuit interruption device may include a single control unit in communication with a plurality of normally-on switching elements, or a plurality of control units in which each control unit is in communication with a respective one of the plurality of normally-on switching elements.

It will also be appreciated that, in embodiments employing the use of a plurality of control units, the circuit interruption device may include a single power extraction circuit which is electrically coupled with each of the plurality of control units, or a plurality of power extraction circuits in which each power extraction circuit is electrically coupled with a respective one of the plurality of control units.

Furthermore the number of control units and power extraction circuits in the circuit interruption device may correspond to the number of switching devices and/or normally-on switching elements.

Preferred embodiments of the invention will now be described, by way of example, with reference to the accompanying drawings in which:

FIG. 1 illustrates current interruption using a conventional AC circuit breaker;

FIGS. 2a and 2b respectively illustrate examples of current interruption using a DC circuit interruption device and an ultrafast, sub-cycle AC circuit interruption device;

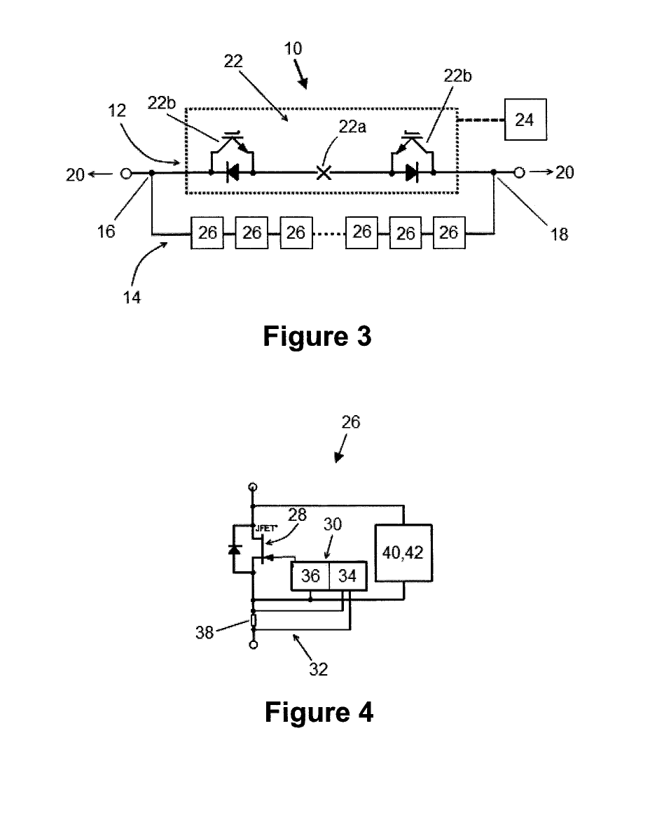

FIG. 3 shows, in schematic form, a circuit interruption device according to a first embodiment of the invention;

FIG. 4 shows, in schematic form, the structure of a switching device forming part of a secondary branch of the circuit interruption device of FIG. 3;

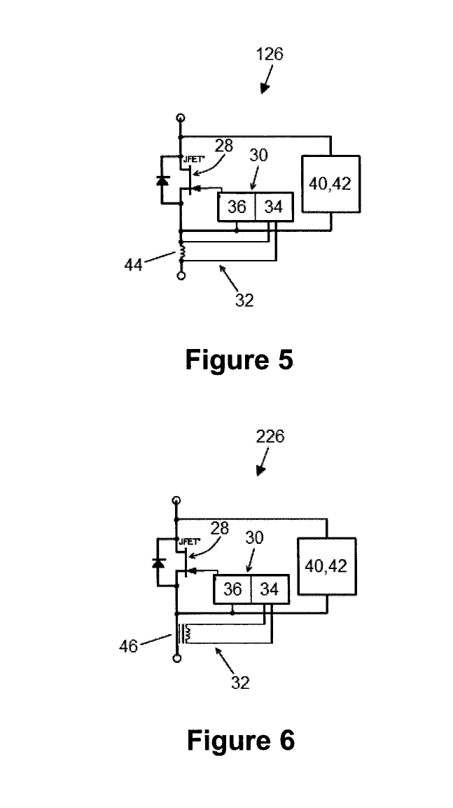

FIG. 5 shows, in schematic form, the structure of a switching device forming part of a secondary branch of a circuit interruption device according to a second embodiment of the invention;

FIG. 6 shows, in schematic form, the structure of a switching device forming part of a secondary branch of a circuit interruption device according to a third embodiment of the invention;

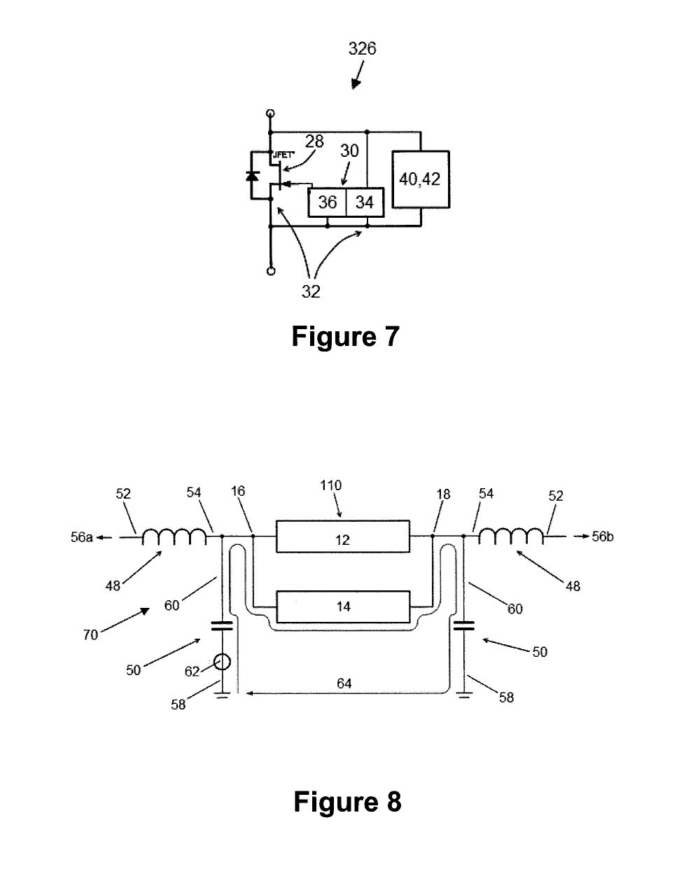

FIG. 7 shows, in schematic form, the structure of a switching device forming part of a secondary branch of a circuit interruption device according to a fourth embodiment of the invention; and

FIG. 8 shows a circuit interruption device assembly according to a fifth embodiment of the invention;

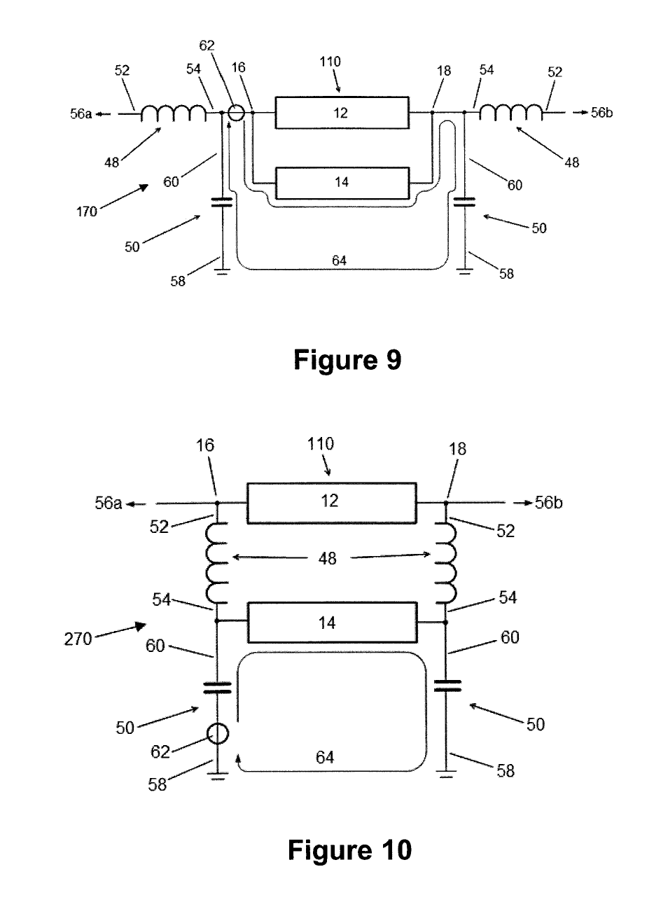

FIG. 9 shows a circuit interruption device assembly according to a sixth embodiment of the invention;

FIG. 10 shows a circuit interruption device assembly according to a seventh embodiment of the invention; and

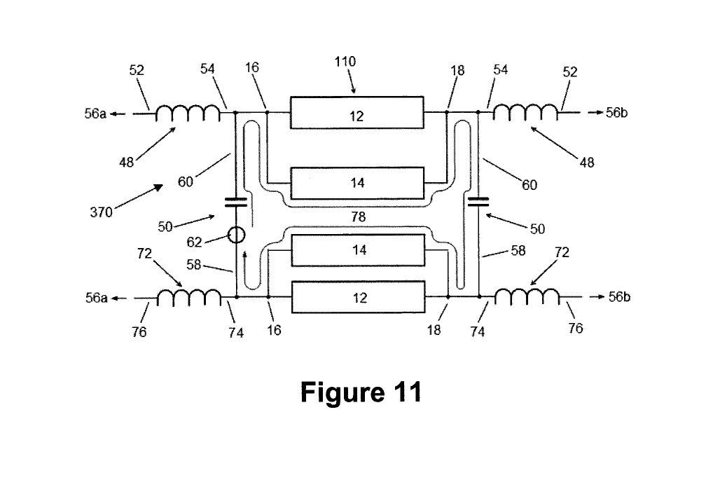

FIG. 11 shows a circuit interruption device assembly according to an eighth embodiment of the invention.

A first circuit interruption device 10 according to a first embodiment of the invention is shown in FIG. 3.

The first circuit interruption device 10 comprises a main branch 12, a secondary branch 14, and first and second terminals 16,18. Each of the main and secondary branches 12,14 extends between the first and second terminals 16,18.

In use, the first and second terminals 16,18 are connected to a DC electrical network 20.

The main branch 12 includes a switching apparatus 22 which includes a mechanical switching element 22a, e.g. a vacuum interrupter switch, connected in series with a plurality of semiconductor switching elements 22b in the form of insulated gate bipolar transistors (IGBT). The first circuit interruption device 10 further includes a main control unit 24 to control the switching of the switching apparatus 22.

In other embodiments of the invention, it is envisaged that the type and number of switching elements in the switching apparatus 22 may vary depending on the design requirements of the main branch 12.

The secondary branch 14 is connected across the main branch 12 and includes a plurality of series-connected first switching devices 26.

FIG. 4 shows, in schematic form, the structure of each first switching device 26. Each first switching device 26 includes a normally-on switching element 28, a secondary control unit 30 and a power extraction circuit 32.

The normally-on switching element 28 of each first switching device 26 is in the form of a depletion-mode junction field effect transistor (JFET). It is envisaged that, in other embodiments of the invention, each depletion-mode JFET may include a wide-band-gap semiconductor material such as silicon carbide, gallium nitride, diamond or any other suitable semiconductor material and/or each depletion-mode JFET may be replaced by a different type of normally-on switching element, e.g. another type of depletion-mode switching element.

Optionally each first switching device 26 may include a plurality of parallel-connected normally-on switching elements, instead of a single normally-on switching element 28, to vary the current rating of each first switching device 26.

The secondary control unit 30 of each first switching device 26 includes a power supply unit 34 and control electronics 36 to control the switching of the corresponding normally-on switching element 28.

The power extraction circuit 32 of each first switching device 26 includes an electrical block which includes a resistor 38. The resistor 38 of each first switching device 26 is connected in series with the corresponding normally-on switching element 28. The power supply unit 34 of each secondary control unit 30 is electrically connected across the corresponding electrical block. In this manner the power extraction circuit 32 of each first switching device 26 is electrically coupled with the corresponding secondary control unit 30.

Each first switching device 26 further includes a snubber circuit 40 and an energy absorption element 42, each of which is connected across the corresponding normally-on switching element 28. Each energy absorption element 42 is in the form of a surge arrestor.

The components of the main and secondary branches 12,14 are rated so that the secondary branch 14 has an electrical on-resistance which is higher than an electrical on-resistance of the main branch 12.

Operation of the first circuit interruption device 10 of FIG. 3 to interrupt current in the DC electrical network 20 is described as follows.

In the normal mode of operation of the first circuit interruption device 10, the switching apparatus 22 is closed and so current from the DC electrical network 20 flows in the main branch 12. Meanwhile each normally-on switching element 28 is in an on-state to permit the secondary branch 14 to conduct current in the normal mode of operation. Little to no current flows in the secondary branch 14 as a consequence of the secondary branch 14 having an electrical on-resistance which is higher than an electrical on-resistance of the main branch 12.

A fault or other abnormal operating condition in the DC electrical network 20 may lead to high fault current flowing through the DC electrical network 20.

In response to an event of high fault current in the DC electrical network 20, the main control unit 24 controls the switching of the switching apparatus 22 to open in order to commutate current from the main branch 12 to the secondary branch 14 in a fault mode of operation of the first circuit interruption device 10. Since each normally-on switching element 28 was already in an on-state to permit the secondary branch 14 to conduct current prior to occurrence of the fault, commutation of the fault current from the main branch 12 to the secondary branch 14 takes place instantaneously.

At this stage the secondary branch 14 sees a current pulse with a short duration and a high rate of change of current, typically 1 to 10 A/μs, and so the flow of current in the secondary branch 14 results in a voltage drop appearing across the resistor 38 of each first switching device 26. The resistor 38 of each first switching device 26 is rated such that the voltage drop appearing across the resistor 38 of each first switching device 26 in the fault mode of operation is suitable to drive the corresponding secondary control unit 30, i.e. power the power supply unit 34 to enable the control electronics 36 to turn off the corresponding normally-on switching element 28. In this manner the power extraction circuit 32 of each first switching device 26 is able to locally derive power for driving the corresponding secondary control unit 30.

After a certain period of time following commutation of the fault current from the main branch 12 to the secondary branch 14, the control electronics 36 of the secondary control unit 30 of each first switching device 26 turns off the corresponding normally-on switching element 28 to inhibit current flow in the secondary branch 14 and thereby commutate the fault current to the corresponding snubber circuit 40 and energy absorption element 42 to complete the circuit interruption procedure.

The aforementioned use and configuration of the plurality of normally-on switching elements 28 in the secondary branch 14 to enable instantaneous commutation of the fault current from the main branch 12 to the secondary branch 14 therefore improves the responsiveness of the first circuit interruption device 10 in performing the circuit interruption procedure.

Furthermore a normally-on switching element 28 does not need to be energised to be in an on-state. As such, it is not essential to provide constant energisation of the or each normally-on switching element 28 to maintain its on-state in order to permit the secondary branch 14 to conduct current during the normal mode of operation, thus improving the efficiency of the first circuit interruption device 10 in terms of operational costs and energy usage.

The configuration of the first circuit interruption device 10 of FIG. 3 therefore results in a cost- and energy-efficient circuit interruption device which can be designed to rapidly and reliably carry out a circuit interruption procedure in response to an occurrence of a fault in the DC electrical network 20.

A second switching device 126 forming part of a secondary branch 14 of a second circuit interruption device according to a second embodiment of the invention is shown in FIG. 5. The secondary branch 14 of the second circuit interruption device includes a plurality of series-connected second switching devices 126. The second circuit interruption device is similar in terms of structure and operation to the first circuit interruption device 10 of FIG. 3, each second switching device 126 as shown in FIG. 5 is similar in terms of structure and operation to each first switching device 26 as shown in FIG. 4, and like features share the same reference numerals.

Each second switching device 126 differs from each first switching device 26 in that the electrical block of each second switching device 126 includes a reactor 44 in place of the resistor 38 shown in FIG. 4.

Following commutation of the fault current from the main branch 12 to the secondary branch 14, the high rate of change of current of the current pulse induces a voltage drop across the reactor 44 of each second switching device 126 and thereby enables the power extraction circuit 32 of each second switching device 126 to extract power from the current flowing in the secondary branch 14 to drive the corresponding secondary control unit 30. The reactor 44 of each second switching device 126 is rated such that the voltage drop appearing across the reactor 44 of each second switching device 126 in the fault mode of operation is suitable to drive the corresponding secondary control unit 30.

A third switching device 226 forming part of a secondary branch 14 of a third circuit interruption device according to a third embodiment of the invention is shown in FIG. 6. The secondary branch 14 of the third circuit interruption device includes a plurality of series-connected third switching devices 226. The third circuit interruption device is similar in terms of structure and operation to the second circuit interruption device, each third switching device 226 as shown in FIG. 6 is similar in terms of structure and operation to each second switching device 126 as shown in FIG. 5, and like features share the same reference numerals.

Each third switching device 226 differs from each second switching device 126 in that the electrical block of each third switching device 226 includes a first winding of a current transformer 46 in place of the reactor 44 as shown in FIG. 5.

Following commutation of the fault current from the main branch 12 to the secondary branch 14, the high rate of change of current of the current pulse induces a voltage drop across the first winding of the current transformer 46 of each third switching device 226. This in turn induces a voltage drop across the corresponding second winding and thereby enables the power extraction circuit 32 of each third switching device 226 to extract power from the current flowing in the secondary branch 14 to drive the corresponding secondary control unit 30. The current transformer 46 of each third switching device 226 is rated such that the voltage drop appearing across its first winding in the fault mode of operation is suitable to drive the corresponding secondary control unit 30.

The use of the current transformer 46 in the electrical block of each third switching device 226 obviates the need for any voltage isolation or “level shifting” which would normally be required for switching devices with an electrical block including a resistor or reactor.

A fourth switching device 326 forming part of a secondary branch 14 of a fourth circuit interruption device according to a fourth embodiment of the invention is shown in FIG. 7. The secondary branch 14 of the fourth circuit interruption device includes a plurality of series-connected fourth switching devices 326. The fourth circuit interruption device is similar in terms of structure and operation to the first circuit interruption device 10 of FIG. 3, each fourth switching device 326 as shown in FIG. 7 is similar in terms of structure and operation to each first switching device 26 as shown in FIG. 4, and like features share the same reference numerals.

Each fourth switching device 326 differs from each first switching device 26 in that:
each fourth switching device 326 omits the resistor 38 as shown in FIG. 4;
the electrical block of each fourth switching device 326 includes the normally-on switching element 28.

In this manner the power extraction circuit 32 of each fourth switching device 326 is able to extract power from the current flowing in the secondary branch 14 by utilising the on-state voltage appearing across the corresponding normally-on switching element 28 when the fault current flows in the secondary branch 14 in the fault mode of operation.

A first circuit interruption device assembly 70 according to a fifth embodiment of the invention is shown in FIG. 8.

The first circuit interruption assembly 70 includes a fifth circuit interruption device 110. A secondary branch 14 of the fifth circuit interruption device 110 includes a plurality of series-connected fifth switching devices. The fifth circuit interruption device 110 is similar in terms of structure and operation to the second circuit interruption device, each fifth switching device is similar in terms of structure and operation to each second switching device 126 as shown in FIG. 5, and like features share the same reference numerals.

The first circuit interruption device assembly 70 further includes a current injection circuit. The current injection circuit includes a pair of first filter limbs 48 and a pair of second filter limbs 50.

Each first filter limb 48 has first and second ends 52,54, and includes an auxiliary reactor. In use, the first end 52 of each first filter limb 48 is connected to a pole of a respective one of a pair of DC electrical networks 56a,56b. The second end 54 of each first filter limb 48 is connected to a respective one of the first and second terminals 16,18 of the fifth circuit interruption device 110.

Each second filter limb 50 has first and second ends 58,60, and includes an auxiliary capacitor. In use, the first end 58 of each second filter limb 50 is connected to ground.

The secondary branch 14 of the fifth circuit interruption device 110 is connected with the second filter limbs 50 to define a Tr-configuration of the secondary branch 14 and second filter limbs 50 in which the secondary branch 14 extends between the second ends 60 of the second filter limbs 50. The Tr-configuration is connected between the first filter limbs 48 such that the second end 54 of each first filter limb 48 is connected to the second end 60 of a respective one of the second filter limbs 50.

The current injection circuit further includes a current source in the form of a driving transformer 62. The driving transformer 62 forms part of one of the second filter limbs 50 such that that second filter limb 50 includes a series connection of a driving transformer 62 and an auxiliary capacitor. In addition the driving transformer 62 is connected between the corresponding auxiliary capacitor and ground.

Connecting the driving transformer 62 on the ground side potential of the current injection circuit obviates the need to install high voltage insulation on the driving transformer 62, thereby decreasing its manufacturing cost.

It is envisaged that, in other embodiments, the driving transformer 62 may be connected at the other side of the auxiliary capacitor which is not connected to ground, i.e. the high voltage side potential of the current injection circuit.

In other embodiments, it is envisaged that the current injection circuit may include a plurality of current sources. This permits redundancy to be included in the current injection circuit for reliability reasons.

In the fault mode of operation of the fifth circuit interruption device 110, the driving transformer 62 is controlled to inject a ripple current into the secondary branch 14. The flow of the ripple current in the secondary branch 14 induces a voltage drop across the reactor of the electrical block of each fifth switching device and thereby enables the power extraction circuit of each fifth switching device to extract power from the ripple current flowing in the secondary branch 14.

The first and second filter limbs 48,50 define line traps which provide a current loop return path 64 which passes through the fifth circuit interruption device 110 and the second filter limbs 50. The inclusion of the line traps in the current injection circuit prevents the injected ripple current from entering the DC electrical networks 56a,56b. The line traps shown in FIG. 8 use first order filter networks but may have higher order filtering with multiple inductive, capacitive and resistive elements in place of the pairs of auxiliary reactors and auxiliary capacitors shown in FIG. 8.

The current injection circuit therefore enables the power extraction circuit of each fifth switching device to reliably extract a required amount of power from the current flowing in the secondary branch 14 through the injection of a suitable ripple current, thus improving the reliability of the fifth circuit interruption device 110.

The driving transformer 62 may be rated so that the injected current on its own or in combination with the fault current is sufficient to enable the power extraction circuit to extract the required amount of power from current flowing in the secondary branch 14 to drive each secondary control unit to turn off the corresponding normally-on switching element 28.

It will be appreciated that the current injection circuit of the first circuit interruption device assembly 70 operates in a similar fashion if the reactor of each fifth switching device is replaced by a first winding of a current transformer 46 as shown in FIG. 6.

A second circuit interruption device assembly 170 according to a sixth embodiment of the invention is shown in FIG. 9. The second circuit interruption device assembly 170 of FIG. 9 is similar in structure and operation to the first circuit interruption device assembly 70 of FIG. 8, and like features share the same reference numerals.

The second circuit interruption device assembly 170 differs from the first circuit interruption device assembly 70 in that, in the second circuit interruption device assembly 170, the driving transformer 62 is connected to the first terminal 16 of the fifth circuit interruption device 110 such that the driving transformer 62 is connected in series with the first and second terminals 16,18 between the second ends 60 of the second filter limbs 50.

Alternatively, in other embodiments, the driving transformer 62 may be connected to the second terminal 18 of the fifth circuit interruption device 110 such that the driving transformer 62 is connected in series with the first and second terminals 16,18 between the second ends 60 of the second filter limbs 50.

A third circuit interruption device assembly 270 according to a seventh embodiment of the invention is shown in FIG. 10. The third circuit interruption device assembly 270 of FIG. 10 is similar in structure and operation to the first circuit interruption device assembly 70 of FIG. 8, and like features share the same reference numerals.

The third circuit interruption device assembly 270 differs from the first circuit interruption device assembly 70 in that, in the third circuit interruption device assembly 270:
the first end 52 of each first filter limb 48 is further connected to a respective one of the first and second terminals 16,18 of the fifth circuit interruption device 110;
the second end 54 of each first filter limb 48 is not connected to a respective one of the first and second terminals 16,18 of the fifth circuit interruption device 110;
the fifth circuit interruption device 110 further includes a plurality of energy storage elements (not shown) for storing and releasing power, each energy storage element being in the form of a capacitor.

Therefore, the secondary branch 14 and the first filter limbs 48 are connected between the first and second terminals 16,18 of the fifth circuit interruption device 110.

Each energy storage element is integral with the secondary control unit of a respective one of the plurality of fifth switching devices. Optionally, in other embodiments, each energy storage element may be a separate component from the corresponding secondary control unit. In addition, in other embodiments, each energy storage element may be any device (other than a capacitor) that is capable of storing and releasing power, e.g. as a battery.

In the normal mode of operation of the fifth circuit interruption device 110, the driving transformer 62 is controlled to inject a ripple current into the secondary branch 14. The flow of the ripple current in the secondary branch 14 induces a voltage drop across the reactor of the electrical block of each fifth switching device and thereby enables the power extraction circuit of each fifth switching device to extract power from the ripple current flowing in the secondary branch 14. The extracted power is then stored in the energy storage element.

The first and second filter limbs 48,50 define line traps which provide a current loop return path 64 which passes through the secondary branch 14 of the fifth circuit interruption device 110 and the second filter limbs 50. This prevents the injected current from entering the main branch 12 of the fifth circuit interruption device 110 as well as the DC electrical networks 56a,56b.

In the fault mode of operation of the fifth circuit interruption device 110, each energy storage element is configured to release the stored power to drive the corresponding secondary control unit in order to turn off the corresponding normally-on switching element 28.

The provision of an energy storage element enables the circuit interruption device assembly to store power during the normal mode of operation to ensure that a required amount of power is available to drive each secondary control unit during the fault mode of operation. This reduces the reliance on the capability of the power extraction circuit to extract sufficient power solely from the fault current flowing in the secondary branch during the fault mode of operation, thus improving the reliability of the circuit interruption device.

Each energy storage element may be rated so that the stored power on its own or in combination with power extracted from the fault current in the fault mode of operation is sufficient to drive the corresponding secondary control unit.

A fourth circuit interruption device assembly 370 according to an eighth embodiment of the invention is shown in FIG. 11. The fourth circuit interruption device assembly 370 of FIG. 11 is similar in structure and operation to the first circuit interruption device assembly 70 of FIG. 8, and like features share the same reference numerals.

The fourth circuit interruption device assembly 370 differs from the first circuit interruption device assembly 70 in that the fourth circuit interruption device assembly 370 further includes a pair of third filter limbs 72 and an additional circuit interruption device 210.

Each third filter limb 72 has first and second ends 74,76. The first end 74 of each third filter limb 72 is connected to the first end 58 of a respective one of the second filter limbs 50. In use, the second end 76 of each third filter limb 72 is connected to another pole of a respective one of the pair of DC electrical networks 56a,56b. In this manner the current injection circuit is directly connected between different poles of the DC electrical networks 56a,56b.

A secondary branch 14 of the additional circuit interruption device 210 includes a plurality of series-connected additional switching devices. The additional circuit interruption device 210 is similar in terms of structure and operation to the fifth circuit interruption device 110, each additional switching device is similar in terms of structure and operation to each fifth switching device, and like features share the same reference numerals. The additional circuit interruption device 210 is connected between the first ends 58 of the second filter limbs 50.

In this manner the first, second and third filter limbs 48,50,72 define a current loop return path 78 which passes though the fifth circuit interruption device 110, the additional circuit interruption device 210 and the second filter limbs 50.

In the fault mode of operation of the fifth circuit interruption device 110, the driving transformer 62 is controlled to inject a ripple current into the secondary branch 14 of each of the fifth and additional circuit interruption devices 110,210. The flow of the ripple current in the secondary branch 14 of each of the fifth and additional circuit interruption devices 110,210 induces a voltage drop across the reactor of the electrical block of each of the fifth and additional switching devices and thereby enables the power extraction circuit of each of the fifth and additional switching devices to extract power from the ripple current flowing in the secondary branch 14 of each of the fifth and additional circuit interruption devices 110,210.

The configuration of the fourth circuit interruption assembly 370 therefore permits the use of a single current injection circuit with a plurality of circuit interruption devices 110,210 to permit reliable extraction of a required amount of power from the current flowing in the secondary branch 14 of each of the plurality of circuit interruption devices 110,210 through the injection of a suitable ripple current. This not only improves the reliability of the fifth and additional circuit interruption devices, but also improves the efficiency of the fifth and additional circuit interruption devices from an operating cost and hardware perspective.

1. A circuit interruption device comprising:
a main branch;
a secondary branch having an electrical on-resistance which is higher than an electrical on-resistance of the main branch; and
first and second terminals for connection, in use, to an electrical network, the main and secondary branches extending between the first and second terminals;
wherein the main branch includes a switching apparatus which is switchable to selectively allow current to flow in the main branch in a normal mode of operation or commutate current from the main branch to the secondary branch in a fault mode of operation, and the secondary branch includes at least one switching device, the or each switching device including at least one normally-on switching element, the secondary branch further including a control unit in communication with the or each normally-on switching element, the secondary branch further including a power extraction circuit which is electrically coupled with the control unit,
wherein during the normal mode of operation the or each normally-on switching element is in an on-state to permit the secondary branch to conduct current, and during the fault mode of operation the control unit controls the switching of the or each normally-on switching element to an off-state to inhibit current flow in the secondary branch,
wherein the power extraction circuit extracts power from current flowing in the secondary branch to drive the control unit.

2. A circuit interruption device according to claim 1 wherein during the fault mode of operation, following commutation of current from the main branch to the secondary branch, the power extraction circuit extracts power from current flowing in the secondary branch to drive the control unit.

3. A circuit interruption device according to claim 1 wherein at least one normally-on switching element is a semiconductor switching element.

4. A circuit interruption device according to claim 3 wherein the semiconductor switching element is a depletion-mode switching element.

5. A circuit interruption device according to claim 1 wherein at least one normally-on switching element includes a wide-band-gap semiconductor material.

6. A circuit interruption device according to claim 1 wherein the power extraction circuit includes an electrical block which is electrically coupled with the control unit, the electrical block being connected in the secondary branch such that a voltage drop is generated across the electrical block when current flows in the secondary branch.

7. A circuit interruption device according to claim 6 wherein the electrical block includes at least one resistive element and/or at least one inductive element.

8. A circuit interruption device according to claim 6 wherein the electrical block is connected in series with at least one normally-on switching element.

9. A circuit interruption device according to claim 6 wherein the electrical block includes at least one normally-on switching element.

10. A circuit interruption device assembly comprising:
a circuit interruption device according to claim 1; and
a current injection circuit including:
at least one current source for injecting a current into the secondary branch of the circuit interruption device; and
at least one filter limb operably connected to the secondary branch of the circuit interruption device to inhibit the injected current from flowing, in use, into the electrical network.

11. A circuit interruption device assembly according to claim 10 wherein the or each filter limb includes at least one inductive element, at least one capacitive element and/or at least one resistive element.

12. A circuit interruption device assembly according to claim 10 wherein the current injection circuit includes:
a pair of first filter limbs, each first filter limb having first and second ends, the first end of each first filter limb being connectable to the electrical network;
a pair of second filter limbs, each second filter limb having first and second ends, the first end of each second filter limb being connectable to ground or the electrical network, the secondary branch of the circuit interruption device being connected with the second filter limbs to define a π-configuration of the secondary branch and second filter limbs in which the secondary branch extends between the second ends of the second filter limbs, the π-configuration being connected between the first filter limbs such that the second end of each first filter limb is connected to the second end of a respective one of the second filter limbs.

13. A circuit interruption device assembly according to claim 12 wherein the first end of each first filter limb is connected to a respective one of the first and second terminals of the circuit interruption device.

14. A circuit interruption device assembly according to claim 12 wherein the second end of each first filter limb is connected to a respective one of the first and second terminals of the circuit interruption device.

15. A circuit interruption device assembly according to claim 14 further including a pair of third filter limbs, each third filter limb having first and second ends, wherein the first end of each third filter limb is connected to the first end of a respective one of the second filter limbs, and the second end of each third filter limb is connectable to the electrical network.

16. A circuit interruption device assembly according to claim 15 further including an additional circuit interruption device, the additional circuit interruption device being connected between the first ends of the second filter limbs.

17. A circuit interruption device assembly according to claim 12 wherein at least one of the second filter limbs includes a current source.

18. A circuit interruption device assembly according to claim 12 wherein at least one current source is connected in series with the first and second terminals between the second ends of the second filter limbs.

19. A circuit interruption device assembly according to claim 10 including an energy storage element for storing and releasing power,
wherein during the normal mode of operation the or each current source injects a current into the secondary branch and the power extraction circuit extracts power from the injected current for storage in the energy storage element, and
wherein during the fault mode of operation the energy storage element releases the stored power to drive the control unit.

20. A circuit interruption device assembly according to claim 19 wherein the energy storage element is integral with the control unit or is a separate component from the control unit.

21. A circuit interruption device assembly according to claim 10 wherein during the fault mode of operation the or each current source injects a current into the secondary branch.
